(19) United States
(12) Patent Application Publication
(10) Pub. No.: US 2022/0245486 A1
(43) Pub. Date: Aug. 4, 2022

(54) PREDICTION DEVICE, PREDICTION METHOD, AND PREDICTION PROGRAM

(71) Applicant: NIPPON TELEGRAPH AND TELEPHONE CORPORATION, Tokyo (JP)

(72) Inventors: Koshin TO, Tokyo (JP); Shinya OI, Tokyo (JP); Yusuke TANAKA, Tokyo (JP); Akira NAKAYAMA, Tokyo (JP); Masaru MIYAMOTO, Tokyo (JP)

(73) Assignee: NIPPON TELEGRAPH AND TELEPHONE CORPORATION, Tokyo (JP)

(21) Appl. No.: 17/622,145

(22) PCT Filed: Jun. 26, 2019
(86) PCT No.: PCT/JP2019/025476

§ 371 Date: Dec. 22, 2021

(51) Int. Cl. G06N 5/04

(52) U.S. Cl. CPC G06N 5/04

(57) ABSTRACT

An estimation device (10) includes an input unit (30) and an estimation unit (32). A first observation value (40) for each of a plurality of observation areas (50), the first observation value being the number of presences (S) of persons who are observation targets at each of a plurality of observation times, and a second observation value (42) for each of a plurality of observation points (52) included in any one of the plurality of observation areas (50), the second observation value being the number of passages (C) of the persons at each of the plurality of observation times, are input to the input unit (30). The estimation unit (32) optimizes an objective function based on the objective function in a simulation Sim, a constraint condition (G) satisfied between the first observation value (40) and the second observation value (42), the first observation value (40), and the second observation value (42) to estimate a parameter (Param_sim).

### TECHNICAL FIELD

The present disclosure relates to an estimation device, an estimation method, and an estimation program.

### BACKGROUND ART

A technology for analyzing a time series of a movement of an observation target includes a technology using a Markov chain that is a stochastic process in which a future state can be estimated from a present state regardless of a past state (for example, Non Patent Literature 1). Further, a data analysis scheme includes a technology using a neural network obtained by deep learning. An example of the neural network includes a long short-term memory (LSTM) (for example, Non Patent Literature 2). Further, a scheme for searching for a parameter indicating a time series of a movement of an observation target includes a technology using Bayesian optimization known as an efficient parameter search scheme (for example, Non Patent Literature 3).

### CITATION LIST

### Non Patent Literature

Non Patent Literature 1: Charles J. Geyer, “Practical Markov Chain Monte Carlo,” Statistical science vol. 7 No. 4, (1992), p. 473-483, Internet search<URL: https://projecteuclid.org/download/pdf_1/euclid.ss/1177011137>
Non Patent Literature 2: S. Hochreiter, J. Schmidhuber, “LONG SHORT-TERM MEMORY,” Neural computation 9.8 (1997), p. 1734-1780, Internet search<URL: https://www.bioinfjku.at/publications/older/2604.pdf>
Non Patent Literature 3: J. Snoek, H. Larochelle, R. P. Adams, “Practical Bayesian Optimization of Machine Learning Algorithms,” In Advances in Neural Information Processing Systems (NIPS), 2012, Internet search<URL: https://papers.nips.cc/paper/4522-practical-bayesian-optimization-of-machine-learning-algorithms.pdf>

### SUMMARY OF THE INVENTION

### Technical Problem

In the related art represented by Non Patent Literatures 1 to 3 above, when measurement data is missing, accuracy of estimation regarding a movement of an observation target may be degraded.

An object of the present disclosure is to provide an estimation device, an estimation method, and an estimation program capable of improving accuracy of estimation for a movement of an observation target.

### Means for Solving the Problem

An estimation device of the present disclosure includes an input unit to which a first observation value for each of a plurality of observation areas, the first observation value being the number of presences of observation targets at each of a plurality of observation times, and a second observation value for each of a plurality of observation points included in any one of the plurality of observation areas, the second observation value being the number of passages of the observation target at each of the plurality of observation times, are input; and an estimation unit configured to optimize a predetermined function based on the predetermined function, a constraint condition satisfied between the first observation value and the second observation value, the first observation value, and the second observation value to estimate a parameter of the predetermined function.

Further, an estimation method of the present disclosure includes inputting, to an input unit, a first observation value for each of a plurality of observation areas, the first observation value being the number of presences of observation targets at each of a plurality of observation times, and a second observation value for each of a plurality of observation points included in any one of the plurality of observation areas, the second observation value being the number of passages of the observation target at each of the plurality of observation times; and optimizing, by an estimation unit, a predetermined function based on the predetermined function, a constraint condition satisfied between the first observation value and the second observation value, the first observation value, and the second observation value to estimate a parameter of the predetermined function.

An estimation program of the present disclosure is an estimation program for causing a computer to execute: receiving a first observation value for each of a plurality of observation areas, the first observation value being the number of presences of observation targets at each of a plurality of observation times, and a second observation value for each of a plurality of observation points included in any one of the plurality of observation areas, the second observation value being the number of passages of the observation target at each of the plurality of observation times; and optimizing a predetermined function based on the predetermined function, a constraint condition satisfied between the first observation value and the second observation value, the first observation value, and the second observation value to estimate a parameter of the predetermined function.

### Effects of the Invention

According to the present disclosure, an effect that it is possible to improve the accuracy of estimation of the movement of the observation target can be obtained.

### BRIEF DESCRIPTION OF DRAWINGS

FIG. 1 is an illustrative diagram illustrating estimation of the number of presences and the number of passages at an arbitrary estimation time by an estimation device of an embodiment.

FIG. 2 is a block diagram illustrating a hardware configuration of an example of the estimation device of the embodiment.

FIG. 3 is a block diagram illustrating a functional configuration of an example of the estimation device of the embodiment.

FIG. 4 is a diagram illustrating an example of a constraint condition.

FIG. 5 is a diagram illustrating another example of a constraint condition.

FIG. 6 is a diagram illustrating an example of geographic information that is an example of auxiliary information.

FIG. 7 is a diagram illustrating an example of event information that is an example of the auxiliary information.

FIG. 8 is a flowchart illustrating an example of a flow of a first estimation process in an estimation process of the estimation device of the embodiment.

FIG. 9 is a flowchart illustrating an example of a flow of a second estimation process of the estimation process of the estimation device of the embodiment.

### DESCRIPTION OF EMBODIMENTS

Hereinafter, an example of an embodiment of the present disclosure will be described with reference to the drawings. The same or equivalent components and parts in the respective drawings are denoted by the same reference signs. Further, ratios of dimensions in the drawings are exaggerated for convenience of description and may differ from actual ratios.

As an example, in the estimation device of the present embodiment, an observation target is a person, and estimation regarding a person flow due to a movement of persons is performed.

The estimation device of the present embodiment estimates a parameter for optimizing a simulation that accurately reproduces at least one of the following two types of observation values. The first observation value is an observation value (hereinafter referred to as a “first observation value”) that is the number of presences of persons present in an observation area (a so-called spatial person flow). The second observation value is an observation value (hereinafter referred to as a “second observation value”) of the number of passages of persons passing through an observation point (a so-called cross-sectional person flow). The estimation device of the present embodiment estimates at least one of the so-called cross-sectional person flow, which is the number of passages of persons passing through the observation point at an arbitrary estimation time, and the so-called spatial person flow, which is the number of presences of persons present in the observation area at the arbitrary estimation time through a simulation.

Further, with the estimation device of the present embodiment, it is possible to perform sufficient estimation even when the first observation value and the second observation value are partially missing.

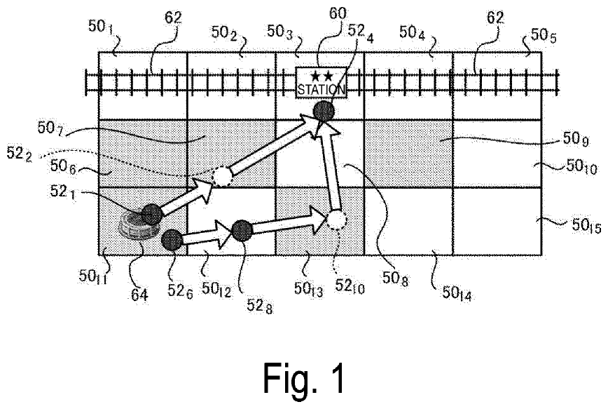

For example, the estimation device of the present embodiment can estimate a parameter for optimizing a simulation for reproducing a person flow with respect to a person flow around a station 60 of a railway, as illustrated in FIG. 1. Further, the estimation device of the present embodiment can estimate at least one of the number of passages and the number of presences through the simulation. In the example illustrated in FIG. 1, the station 60 is present in an observation area 50₃, and railroad tracks are provided in observation areas 50₁ to 50₅. Further, in the example illustrated in FIG. 1, an event venue 64 is provided in an observation area 50₁₁. Hereinafter, when a plurality of observation areas 50 (15 areas: 50₁ to 50₁₅ in FIG. 1) are collectively referred to without distinguishment, reference signs for distinguishing the individual observation areas are omitted and the observation areas are referred to as an “observation area 50.” Similarly, when a plurality of observation points 52 (6 points: 52₁ to 52₁₀ in FIG. 1) to be described below are collectively referred to without distinguishment, reference signs for distinguishing the individual observation points are omitted and the observation points are referred to as an “observation point 52.”

The first observation value, which is an observation value of the number of presences, is obtained for each of the observation areas 50₆, 50₇, 50₉, and 50₁₃ among the observation areas 50₁ to 50₁₅. On the other hand, the first observation value is not obtained for the observation areas 50₁ to 50₅, 50₈, 50₁₀, 50₁₂, 50₁₄, and 50₁₅. Further, the second observation value, which is an observation value of the number of passages, is obtained for the observation points 52₁ and 52₆ in the observation area 50₁₁, the observation point 52₈ in the observation area 50₁₂, and the observation point 52₄ in the observation area 50₃. On the other hand, the second observation value is not obtained for the observation point 52₂ in the observation area 50₇ and the observation point 52₁₀ in the observation area 50₁₃.

With the estimation device of the present embodiment, even when both the observation area 50 in which the first observation value is obtained and the observation point 52 in which the second observation value is obtained are present as described above, it is possible to generate population data of a simulation for reproducing the first observation value and the second observation value, and estimate the parameter for optimizing the simulation. Thus, with the estimation device of the present embodiment, it is possible to estimate at least one of the number of passages of persons passing through the desired observation point 52 at an arbitrary estimation time and the number of presences of persons present in the desired observation area 50 at the arbitrary estimation time, by using the simulation. The arbitrary time includes a (future) time after a present point in time that is, for example, a point in time when the first observation value and the second observation value are obtained, and a (past) time before the present point in time.

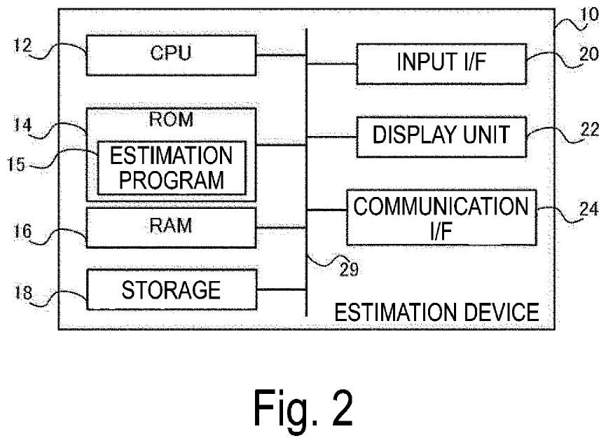

FIG. 2 is a block diagram illustrating a hardware configuration of an example of the estimation device 10 of the present embodiment.

As illustrated in FIG. 2, the estimation device 10 includes a central processing unit (CPU) 12, a read only memory (ROM) 14, a random access memory (RAM) 16, a storage 18, an input interface (I/F) 20, a display unit 22, and a communication interface (I/F) 24. The respective components are communicably connected to each other via a bus 29.

The CPU 12 is a central processing unit that executes various programs or controls each unit. That is, the CPU 12 reads various programs such as the estimation program 15 from the ROM 14, and executes the programs using the RAM 16 as a work area. The CPU 12 performs control of each of the components and various operations according to the programs stored in the ROM 14. In the present embodiment, as illustrated in FIG. 2, the estimation program 15 is stored in the RAM 16, but the present embodiment is not limited thereto and, for example, the estimation program 15 may be stored in the storage 18.

The ROM 14 stores various programs including the estimation program 15 and various pieces of data. The RAM 16 is a work area that temporarily stores a program or data. The storage 18 is configured of a hard disk drive (HDD) or a solid state drive (SSD), and stores various programs including an operating system and various pieces of data.

The input I/F 20 includes a pointing device such as a mouse, and a keyboard, and is used to perform various inputs. The input I/F 20 is not limited to the present embodiment, and may have a form that can be used to perform various inputs by voice.

The display unit 22 is, for example, a liquid crystal display and displays various types of information. The display unit 22 may adopt a touch panel scheme to function as the input I/F 20. Further, the display unit 22 is not limited to a visible display, and may have a function of performing an audible display such as a speaker.

The communication I/F 24 is an interface for communicating with, for example, a device external to the estimation device 10, and standards such as Ethernet (registered trademark), FDDI, and Wi-Fi (registered trademark) are used.

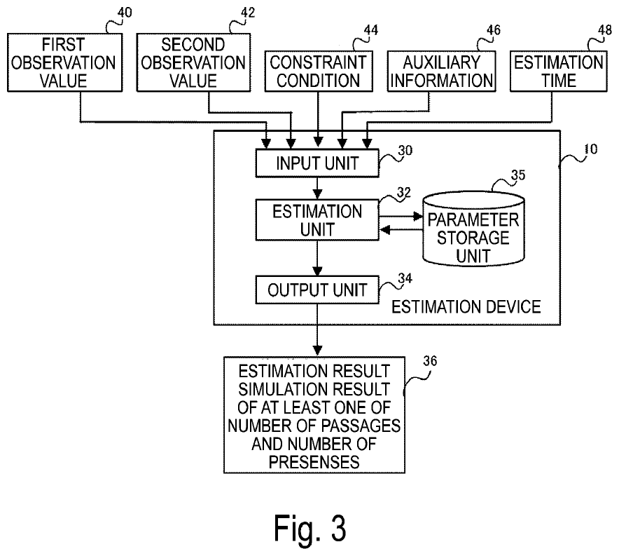

Next, a functional configuration of the estimation device 10 will be described. FIG. 3 is a block diagram illustrating the functional configuration of an example of the estimation device 10.

As illustrated in FIG. 3, the estimation device 10 of the present embodiment includes an input unit 30 and an estimation unit 32 as functional components. Further, as an example, the estimation device 10 of the present embodiment further includes an output unit 34 and a parameter storage unit 35. Each function component is realized by the CPU 12 reading the estimation program 15 stored in the ROM 14, loading the estimation program 15 into the RAM 16, and executing the estimation program 15.

A first observation value 40 and a second observation value 42 are input to the input unit 30, which outputs the first observation value 40 and the second observation value 42, which have been input, to the estimation unit 32. The first observation value 40 is an observation value of the number of persons that are present in the observation area 50 at an arbitrary observation time, as described above. Further, the second observation value 42 is an observation value of the number of passages of persons passing through the observation point at an arbitrary observation time, as described above. A plurality of first observation values 40 and second observation values 42 are input to the input unit 30. The respective numbers of first observation values 40 and second observation values 42 input to the input unit 30 are not limited and may be, for example, numbers depending on estimation accuracy of the estimation device 10 and a size of an area that is an estimation target. Further, the numbers of first observation values 40 and second observation values 42 to be input may be the same or different.

Further, a constraint condition 44 and auxiliary information 46, which will be described in detail below, are input to the input unit 30, and the constraint condition 44 and the auxiliary information 46, which have been input, are output to the estimation unit 32. Further, an estimation time 48, which is a time that is an estimation target, is input to the input unit 30, and the input auxiliary information 46 is output to the estimation unit 32. In the estimation device 10 of the present embodiment, the auxiliary information 46 is not always input, and may not be input.

The first observation value 40, the second observation value 42, the constraint condition 44, the auxiliary information 46, and the estimation time 48 are input from the input unit 30 to the estimation unit 32. The estimation unit 32 of the present embodiment executes a simulation Sim that satisfies a constraint condition G shown in Equation (1) or (2) below to obtain at least one of the number of passages and the number of presences as an estimation result of the simulation. Equation (1) represents the simulation Sim that is executed when the auxiliary information 46 is not input to the input unit 30, and Equation (2) represents a simulation Sim that is used when the auxiliary information 46 is input to the input unit 30.

$$\begin{matrix}[ Math . 1 ] & \\ Sim ( S , C , Param\_sim ) s . t . G ( S , C ) & ( 1 ) \\ \begin{matrix}Sim ( S , C , Param\_sim , A ) s . t . G ( S , C , A ) \\ A = ( M , E , Tr )\end{matrix} \} & ( 2 )\end{matrix}$$

In Equations (1) and (2) above, S is the first observation value 40 and includes a missing value. Further, C is the second observation value 42 and includes a missing value. Further, Param_sim is various parameters that are used in the simulation Sim. Examples of Param_sim include a walking speed of a person. Further, s. t represents subject to. Further, G represents the constraint condition 44. The constraint condition G (the constraint condition 44) is a constraint condition that is satisfied between the first observation value 40 and the second observation value 42.

Examples of the constraint condition G may include a constraint condition for sizes of the number of presences S in the observation area 50 and the number of passages C forming a part of the number of presences S.

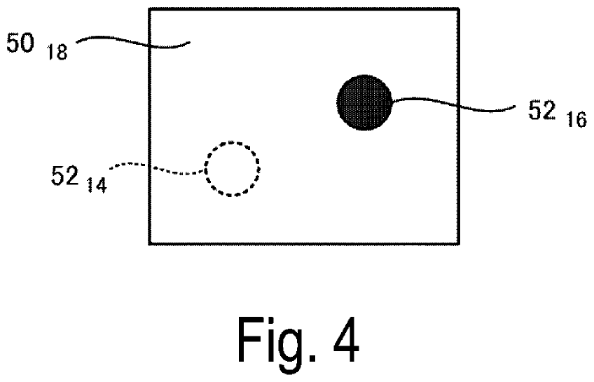

For example, as illustrated in FIG. 4, it is assumed that the first observation value 40 of a number of presences S_{i, t} in the observation area 50₁₈ is obtained. It is also assumed that the number of passages C_{i, 1, t} at the observation point 52₁₄ in the observation area 50₁₈ is not obtained, and the number of passages C_{i, 2, t} at the observation point 52₁₆ in the observation area 50₁₈ is obtained. i in the number of presences S_{i, t} and the number of passages C_{i, t} is a sign representing the observation area 50, and t is a sign representing the observation time. In this case, for example, Equation (3) below is satisfied as the constraint condition G. Equation (3) below represents the constraint condition G in which the number of presences S_{i, t} is equal to or greater than a value obtained by adding the number of passages C_{i, 1, t} to the number of passages C_{i, 2, t}.

[Math. 2]

S_{i,t}≥C_{i,1,t}+C_{i,2,t} (3)

Further, an example of the constraint condition G may include a constraint condition for a range of the observation area 50, which has an influence on the number of presences S in a certain observation area 50.

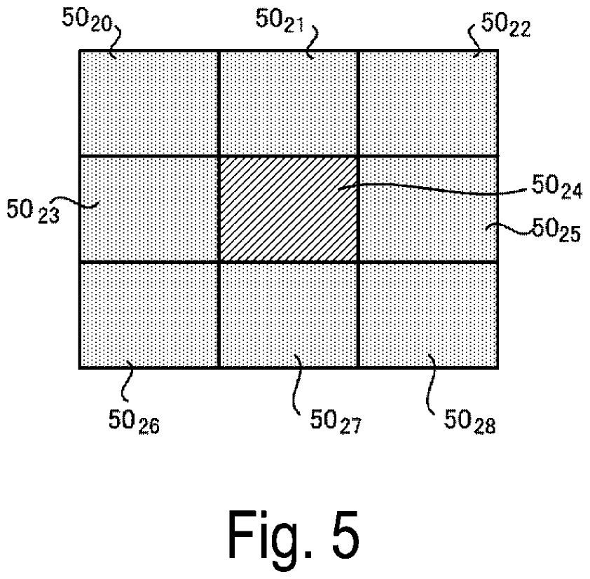

For example, in an example illustrated in FIG. 5, when a moving speed of a person is taken into consideration, a number of presences S_{j, t} in each of the observation areas 50₂₀ to 50₂₃ and 50₂₅ to 50₂₈ at time t can have an influence on the number of presences S_{i, t+1} of the observation area 50₂₄ at time t+1. Thus, the constraint condition G using the observation areas 50₂₀ to 50₂₃ and 50₂₅ to 50₂₈ is satisfied for the estimation of the number of presences S in the observation area 50₂₄.

Needless to say, the constraint condition G is not limited to each of the examples.

Further, in Equation (2) above, A represents the auxiliary information 46. Auxiliary information A (the auxiliary information 46) is auxiliary information that has an influence on a movement of a person who is an observation target. Using the auxiliary information A, it is possible to improve accuracy of derivation of a parameter regarding a correlation between the number of presences S and the number of passages C. In the present embodiment, geographic information M, event information E, and transportation volume information Tr of a transportation facility are used as an example of the auxiliary information A.

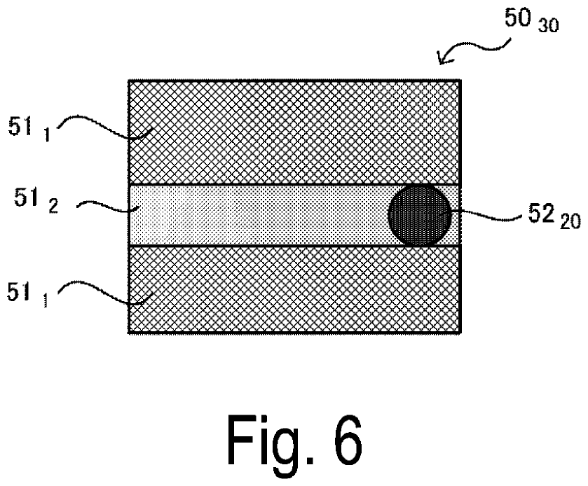

The geographic information M is information indicating whether or not an area is an area in which persons can walk. For example, according to the geographic information M, it is possible to consider a degree of person flow that the observation point 52 can cover in the entire observation area 50 when there is one observation point 52 in the observation area 50. A specific example of the geographic information M will be described with reference to FIG. 6. In an observation area 50₃₀ illustrated in FIG. 6, the area in which persons can walk is limited. In the example illustrated in FIG. 6, an area 51₁ is an area such as a forest that persons do not pass through, an area 51₂ is an area such as a pedestrian path that is used for persons to pass through, and an observation point 52₂₀ is a point on the area 51₂. In this case, only a portion of the area 51₂ may be considered for the number of presences S_{i, t} of the observation area 50₃₀. In the example illustrated in FIG. 6, a ratio of the number of passages C_{i, 1, t} of the observation point 52₂₀ to the number of presences S_{i, t} of the observation area 50₃₀ becomes high.

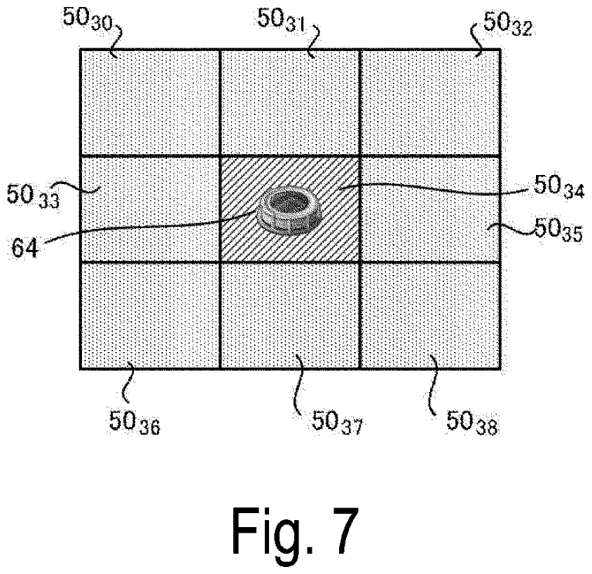

Further, the event information E is information indicating a position of the observation area 50 in which the event venue 64 in which various events are performed is provided, a start time of the events, an end time of the events, and the like. For example, a person flow moving toward the event venue 64 increases before and after the start time of the event. On the other hand, a person flow moving from the event venue 64 to other places increases before and after the end time of the event. Thus, it is preferable to perform the estimation separately from other time periods before and after the start time and the end time of the event. A specific example of the event information E will be described with reference to FIG. 7. In the example illustrated in FIG. 7, the event venue 64 is present in an observation area 50₃₄. Thus, before and after a start time of an event, a person flow from observation areas 50₃₀ to 50₃₃ and 50₃₅ to 50₃₈ around the observation area 50₃₄ to the observation area 50₃₄ increases, and the number of presences Sᵢ of the observation area 50₃₃ increases. On the other hand, before and after an end time of the event, a person flow from the observation area 50₃₄ to the observation areas 50₃₀ to 50₃₃ and 50₃₅ to 50₃₈ around the observation area 50₃₄ increases, and the number of presences Sᵢ of the observation area 50₃₃ decreases.

Further, the transportation volume information Tr of the transportation facility is information representing a transportation volume by public transportation facilities such as railroads and buses and transportation facilities such as vehicles, which can have an influence on the number of presences S and the number of passages C. A specific example of the transportation volume information Tr of the transportation facility will be described with reference to FIG. 1. In the example illustrated in FIG. 1, when the number of passengers who use the station 60 of the railway is relatively large, the number of passengers, an arrival time of the railway, and the like have a great influence on the number of presences S_{i, t} in the observation area 50₃ and the number of passages C_{i, 1, t} of the observation point 52₄ around a ticket gate.

Needless to say, the auxiliary information A is not limited to each of the examples and may be, for example, any one of the geographic information M, the event information E, and the transportation volume information Tr of the transportation facility. Further, for example, the auxiliary information A may be weather information of the observation area 50 and the observation point 52.

In the estimation unit 32, optimization of an objective function in the simulation Sim shown in Equation (1) or (2) above is performed by an objective function expressed by using the following two values being optimized under a condition that a simulation result satisfies the constraint condition G. The first value is an absolute value of a difference between the first observation value 40 and a simulation result corresponding to the first observation value 40. The second value is an absolute value of a difference between the second observation value 42 and a simulation result corresponding to the second observation value 42. For example, for the estimation of the number of presences S at an arbitrary estimation time 48, an absolute value |S−S′| of a difference between a number of presences S′, which is a simulation result at the arbitrary estimation time 48, and an observation value S becomes an objective function. Further, for example, for the estimation of the number of passages C at the arbitrary estimation time 48, an absolute value |C−C′| of a difference between a number of passages C′, which is a simulation result at the arbitrary estimation time 48, and an observation value C becomes an objective function. The objective function of the present embodiment is an example of a predetermined function of the present disclosure.

In the above optimization, the estimation unit 32 of the present embodiment changes the parameter Param_sim while repeatedly executing the simulation Sim. However, the estimation unit 32 of the present embodiment treats the number of presences S and the number of passages C, which are not observed the during repeated execution of the simulation Sim, as some kind of parameters, and changes the numbers in the same manner as the parameter Param_sim. Thus, the estimation unit 32 of the present embodiment changes all of the parameters Param_sim, the number of presences S, and the number of passages C during the execution of the simulation Sim.

As an example, in the present embodiment, the parameter Param_sim of the simulation Sim optimized by the estimation unit 32 is stored in the parameter storage unit 35. The parameter storage unit 35 is, for example, the storage 18 or the like. As an example, in the present embodiment, an initial value of the parameter Param_sim is stored in the parameter storage unit 35 in advance.

Further, the estimation unit 32 of the present embodiment executes the simulation Sim based on Equation (1) or (2) above using the parameter Param_sim stored in the parameter storage unit 35, derives the simulation result according to the arbitrary estimation time 48, and outputs the simulation result to the output unit 34. The output unit 34 sets the simulation result input from the estimation unit 32 as the estimation result 36 and outputs the estimation result 36 to the outside of the estimation device 10 using the communication I/F 24 or the like. The present disclosure is not limited to the present embodiment, and the output unit 34 may output the estimation result 36 to the display unit 22 of the own device so that the estimation result 36 is displayed on the display.

Next, an operation of the estimation device 10 of the present embodiment will be described.

An estimation process of the estimation device 10 of the present embodiment includes a first estimation process for estimating the parameter Param_sim, and a second estimation process for estimating at least one of the number of presences S and the number of passages C due to execution of the simulation Sim according to Equation (1) or (2) above to which the estimated parameter Param_sim has been applied.

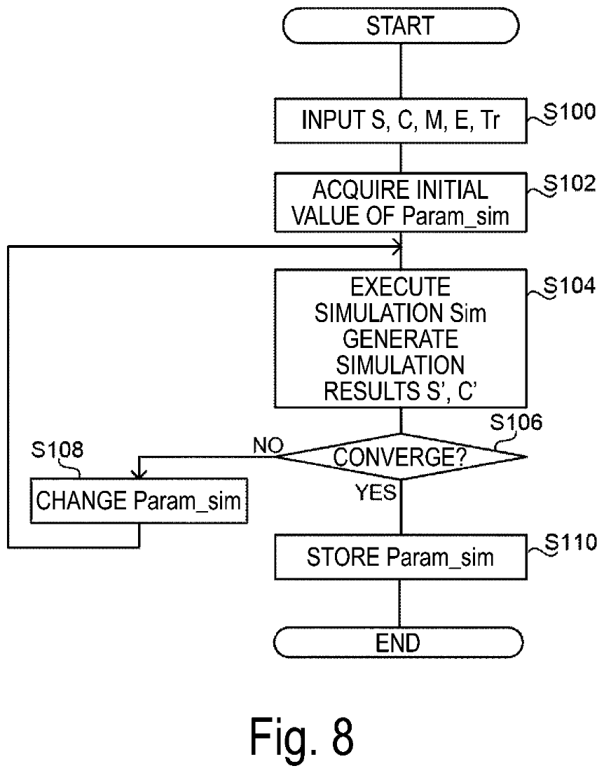

First, the first estimation process will be described. FIG. 8 is a flowchart illustrating an example of a flow of the first estimation process in the estimation process of the estimation device 10 of the present embodiment. The first estimation process is performed by the CPU 12 reading the estimation program 15 from the ROM 14, loading the estimation program 15 into the RAM 16, and executing the estimation program 15. In the first estimation process illustrated in FIG. 8, it is assumed that the constraint condition G is obtained within the estimation device 10 in advance.

In step S100, the number of presences S, which is the first observation value 40, and the number of passages C, which is the second observation value 42, are input to the CPU 12 as the input unit 30. Further, the geographic information M, the event information E, and the transportation volume information Tr of the transportation facility, which are auxiliary information A, are input to the CPU 12 as the input unit 30. In FIG. 8, a form in which the auxiliary information A, which is the auxiliary information 46, is input to the input unit 30 is illustrated, but the input of the auxiliary information A is not essential as described above.

Then, in step S102, the CPU 12 as the estimation unit 32 acquires the initial value of the parameter Param_sim from the parameter storage unit 35, as described above.

Then, in step S104, the CPU 12 as the estimation unit 32 applies the parameter Param_sim based on Equation (1) or (2) above to execute the simulation Sim as described above, and generates the number of presences S′ and the number of passages C′, which are the simulation result.

Then, in step S106, the CPU 12 as the estimation unit 32 determines whether or not the simulation result has converged. As an example, in the present embodiment, when an absolute value of a difference between the observation value (S, C) and the simulation result (S′, C′) is within a predetermined range, the CPU 12 regards the parameter Param_sim as having converged. When the parameter Param_sim has not converged, in other words, when the absolute value of the difference between the observation value (S, C) and the simulation result (S′, C′) is out of the predetermined range, the determination in step S106 becomes a negative determination (NO) and the CPU 12 as the estimation unit 32 proceeds to step S108. In step S108, the CPU 12 as the estimation unit 32 changes the value of the parameter Param_sim and then, returns to step S104 so that the simulation Sim to which the changed parameter Param_sim has been applied is executed.

On the other hand, when the value of the parameter Param_sim converges, in other words, when the absolute value of the difference between the observation value (S, C) and the simulation result (S′, C′) is within the predetermined range, the determination in step S106 becomes a positive determination (YES), and the CPU 12 as the estimation unit 32 proceeds to step S110.

In step S110, the CPU 12 as the estimation unit 32 stores the parameter Param_sim in the parameter storage unit 35 and then, ends the first estimation process.

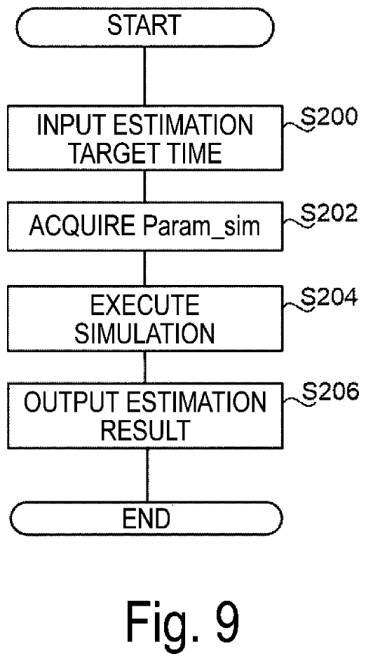

Next, the second estimation process will be described. FIG. 9 is a flowchart illustrating an example of a flow of the second estimation process in the estimation process of the estimation device 10 of the present embodiment. The second estimation process is performed by the CPU 12 reading the estimation program 15 from the ROM 14, loading the estimation program 15 into the RAM 16, and executing the estimation program 15.

In step S200, the arbitrary estimation time 48 is input to the CPU 12 as the input unit 30.

Then, in step S202, the CPU 12 as the estimation unit 32 acquires the parameter Param_sim from the parameter storage unit 35.

Then, in step S204, the CPU 12 as the estimation unit 32 applies the parameter Param_sim based on Equation (1) or (2) above to execute the simulation Sim as described above. The CPU 12 as the estimation unit 32 generates at least one of the number of presences S′ and the number of passages C′, which are simulation results, and outputs the simulation result to the output unit 34.

Then, in step S206, the CPU 12 as the output unit 34 outputs the estimation result 36 as described above and, then ends the second estimation process.

In the present embodiment, a form in which the first estimation process and the second estimation process performed in the estimation device 10 are treated as separate processes has been described above by way of example, but the present disclosure is not limited to the embodiment, and the first estimation process and the second estimation process may be treated as a series of processes. When the first estimation process and the second estimation process are treated as separate processes as in the present embodiment, the estimation programs 15 may also be separate programs corresponding to the respective processes. Further, a function of the estimation unit 32 that performs the first estimation process and a function of the estimation unit 32 that performs the second estimation process may be included in the separate estimation devices 10.

As described above, the estimation device 10 of the present embodiment includes the input unit 30 and the estimation unit 32. The first observation value 40 for each of the plurality of observation areas 50, the first observation value being the number of presences S of persons that are observation targets at each of a plurality of observation times, and the second observation value 42 for each of the plurality of observation points 52 included in any one of the plurality of observation areas 50, the second observation value being the number of passages C of the persons at each of the plurality of observation times, are input to the input unit 30. The estimation unit 32 optimizes the objective function based on the objective function in the simulation Sim, the constraint condition G satisfied between the first observation value 40 and the second observation value 42, the first observation value 40, and the second observation value 42 to estimate the parameter Param_sim.

The estimation device 10 of the present embodiment repeatedly executes the simulation Sim based on the constraint condition G, the first observation value 40, and the second observation value 42 to minimize a difference between the observation value (S, C) and the simulation result (S′, C′), thereby estimating the parameter Param_sim. Thus, the estimation device 10 of the present embodiment can perform highly accurate estimation even when the observation values of the number of presences S and the number of passages C have missing values.

In the present embodiment, a form in which the observation target is a person has been described, but the observation target is not limited to this form. For example, the observation target may be a vehicle. As described above, the estimation device of the present disclosure can be applied to data having a time series.

In each of the embodiments, various processors other than the CPU may execute the estimation process executed by the CPU reading software (program). In this case, examples of the processor may include a programmable logic device (PLC) of which a circuit configuration can be changed after manufacture of a field-programmable gate array (FPGA), and a dedicated electric circuit that is a processor having a circuit configuration specially designed so that a specific process is executed, such as an application specific integrated circuit (ASIC). Further, the estimation process may be executed by one of these various processors or may be executed by a combination of two or more processors of the same type or different types (for example, a combination of a plurality of FPGAs or a combination of a CPU and an FPGA). Further, a hardware structure of these various processors is, more specifically, an electric circuit in which circuit elements such as semiconductor elements are combined.

Further, an aspect in which the estimation program 15 is stored (installed) in the ROM 14 in advance has been described in each of the embodiments, but the present disclosure is not limited thereto. The program may be provided in a form of being in a non-transitory storage medium such as a compact disk read only memory (CD-ROM), a digital versatile disk only memory (DVD-ROM), or a universal serial bus (USB) memory. Further, the program may be downloaded from an external device via a network.

The following supplement will be further disclosed for the embodiments.

(Supplement Item 1)

An estimation device includes:
a memory; and
a processor connected to the memory,
wherein the processor receives
a first observation value for each of a plurality of observation areas, the first observation value being the number of presences of observation targets at each of a plurality of observation times, and a second observation value for each of a plurality of observation points included in any one of the plurality of observation areas, the second observation value being the number of passages of the observation target at each of the plurality of observation times, and
optimizes a predetermined function based on the predetermined function, a constraint condition satisfied between the first observation value and the second observation value, the first observation value, and the second observation value to estimate a parameter of the predetermined function.

(Supplement Item 2)

A non-transitory storage medium that stores a program that can be executed by a computer so that an estimation process is executed,
wherein, in the estimation process, when a first observation value for each of a plurality of observation areas, the first observation value being the number of presences of observation targets at each of a plurality of observation times, and a second observation value for each of a plurality of observation points included in any one of the plurality of observation areas, the second observation value being the number of passages of the observation target at each of the plurality of observation times are input, a predetermined function is optimized based on the predetermined function, a constraint condition satisfied between the first observation value and the second observation value, the first observation value, and the second observation value, thereby estimating a parameter of the predetermined function.

### REFERENCE SIGNS LIST

10 Estimation device
12 CPU
14 ROM
15 Estimation program
18 Storage
30 Input unit
32 Estimation unit
40 First observation value
42 Second observation value
44 Constraint condition
46 Auxiliary information

1. An estimation device comprising circuitry configured to execute a method comprising:
receiving as input a first observation value for each of a plurality of observation areas, the first observation value being a number of presences of observation targets at each of a plurality of observation times, and a second observation value for each of a plurality of observation points included in any one of the plurality of observation areas, the second observation value being a number of passages of the observation target at each of the plurality of observation times; and
optimizing a predetermined function based on the predetermined function, a constraint condition satisfied between the first observation value and the second observation value, the first observation value, and the second observation value to estimate a parameter of the predetermined function.

2. The estimation device according to claim 1,
wherein the predetermined function is a function for calculating the number of presences of the observation targets at a time for each area and the number of passages of the observation targets at each time for each point, and the circuitry further configured to execute a method comprising:
optimizing an objective function expressed by using a difference between the first observation value and a calculation result corresponding to the first observation value, and a difference between the second observation value and a calculation result corresponding to the second observation value under a condition that the calculation result satisfies the constraint condition to estimate the parameter of the predetermined function.

3. The estimation device according to claim 1, wherein the constraint condition includes is that the first observation value at the observation time for the observation area is equal to or greater than a sum of the second observation values at the observation time for the plurality of observation points included in the observation area.

4. The estimation device according to claim 1, the circuitry further configured to execute a method comprising:
estimating the parameter using auxiliary information having an influence on a movement of the observation target.

5. The estimation device according to claim 1, the circuitry further configured to execute a method comprising:
estimating at least one of the number of passages of the observation targets at an arbitrary estimation time at any one of the plurality of observation points, and the number of presences of the observation targets at the arbitrary estimation time in any one of the plurality of observation areas.

6. An estimation method comprising:
inputting a first observation value for each of a plurality of observation areas, the first observation value being a number of presences of observation targets at each of a plurality of observation times, and a second observation value for each of a plurality of observation points included in any one of the plurality of observation areas, the second observation value being a number of passages of the observation target at each of the plurality of observation times; and
optimizing a predetermined function based on the predetermined function, a constraint condition satisfied between the first observation value and the second observation value, the first observation value, and the second observation value to estimate a parameter of the predetermined function.

7. A computer-readable non-transitory recording medium storing computer-executable program instructions that when executed by a processor cause a computer system to execute a method comprising:
receiving a first observation value for each of a plurality of observation areas, the first observation value being a number of presences of observation targets at each of a plurality of observation times, and a second observation value for each of a plurality of observation points included in any one of the plurality of observation areas, the second observation value being a number of passages of the observation target at each of the plurality of observation times; and
optimizing a predetermined function based on the predetermined function, a constraint condition satisfied between the first observation value and the second observation value, the first observation value, and the second observation value to estimate a parameter of the predetermined function.

8. The estimation device according to claim 2, wherein the constraint condition includes the first observation value at the observation time for the observation area is equal to or greater than a sum of the second observation values at the observation time for the plurality of observation points included in the observation area.

9. The estimation device according to claim 2, the circuitry further configured to execute a method comprising: estimating the parameter using auxiliary information having an influence on a movement of the observation target.

10. The estimation method according to claim 6, wherein the predetermined function is a function for calculating the number of presences of the observation targets at a time for each area and the number of passages of the observation targets at each time for each point, and the method further comprising:
optimizing an objective function expressed by using a difference between the first observation value and a calculation result corresponding to the first observation value, and a difference between the second observation value and a calculation result corresponding to the second observation value under a condition that the calculation result satisfies the constraint condition to estimate the parameter of the predetermined function.

11. The estimation method according to claim 6, wherein the constraint condition includes the first observation value at the observation time for the observation area is equal to or greater than a sum of the second observation values at the observation time for the plurality of observation points included in the observation area.

12. The estimation method according to claim 6, the method further comprising:
estimating the parameter using auxiliary information having an influence on a movement of the observation target.

13. The estimation method according to claim 6, the method further comprising:
estimating at least one of the number of passages of the observation targets at an arbitrary estimation time at any one of the plurality of observation points, and the number of presences of the observation targets at the arbitrary estimation time in any one of the plurality of observation areas.

14. The computer-readable non-transitory recording medium according to claim 7, wherein the constraint condition includes the first observation value at the observation time for the observation area is equal to or greater than a sum of the second observation values at the observation time for the plurality of observation points included in the observation area.

15. The computer-readable non-transitory recording medium according to claim 7, wherein the constraint condition includes the first observation value at the observation time for the observation area is equal to or greater than a sum of the second observation values at the observation time for the plurality of observation points included in the observation area.

16. The computer-readable non-transitory recording medium according to claim 7, the computer-executable program instructions when executed further causing the computer system to execute a method comprising:
estimating the parameter using auxiliary information having an influence on a movement of the observation target.

17. The computer-readable non-transitory recording medium according to claim 7, the computer-executable program instructions when executed further causing the computer system to execute a method comprising:
estimating at least one of the number of passages of the observation targets at an arbitrary estimation time at any one of the plurality of observation points, and the number of presences of the observation targets at the arbitrary estimation time in any one of the plurality of observation areas.

18. The estimation method according to claim 10, wherein the constraint condition includes the first observation value at the observation time for the observation area is equal to or greater than a sum of the second observation values at the observation time for the plurality of observation points included in the observation area.

19. The estimation method according to claim 10, further comprising: estimating the parameter using auxiliary information having an influence on a movement of the observation target.

20. The computer-readable non-transitory recording medium according to claim 14, wherein the constraint condition includes the first observation value at the observation time for the observation area is equal to or greater than a sum of the second observation values at the observation time for the plurality of observation points included in the observation area.
